(19) United States
(12) Patent Application Publication
(10) Pub. No.: US 2020/0410788 A1
(43) Pub. Date: Dec. 31, 2020

(54) MANAGEMENT APPARATUS, VEHICLE, INSPECTION APPARATUS, AND VEHICLE INSPECTION SYSTEM AND INFORAMTION PROCESSING METHOD THEREFOR

(71) Applicants: SONY CORPORATION, Tokyo (JP); SONY SEMICONDUCTOR SOLUTIONS CORPORATION, Atsugi-shi, Kanagawa (JP)

(72) Inventors: Hiromasa UCHIYAMA, Tokyo (JP); Ryuta SATOH, Kanagawa (JP); Yukio KINOSHITA, Kanagawa (JP)

(73) Assignees: Sony Corporation, Tokyo (JP); Sony Semiconductor Solutions Corporation, Atsugi-shi, Kanagawa (JP)

(21) Appl. No.: 16/643,628

(22) PCT Filed: Aug. 28, 2018
(86) PCT No.: PCT/JP2018/031666

§ 371 Date: Mar. 2, 2020

(30) Foreign Application Priority Data
Sep. 11, 2017 (JP) 2017-173967

(51) Int. Cl. G07C 5/08; G06Q 10/00; G07C 5/00; G05D 1/00; G01M 17/007; G01S 17/931

(52) U.S. Cl. CPC G07C 5/0816; G06Q 10/20; G07C 5/008; G01S 17/931; G07C 5/085; G01M 17/007; G05D 1/0011

(57) ABSTRACT

The present technology relates to a management apparatus, a vehicle, an inspection apparatus, and a vehicle inspection system and an information processing method therefor by which more efficient vehicle inspection can be implemented. The vehicle inspection system includes a vehicle that is an inspection target vehicle, an inspection apparatus that inspects, as a third party, the vehicle, and a management apparatus. The management apparatus decides feedback information based on a result of determination obtained when a vehicle state of the vehicle is determined using first inspection data based on a result of inspection of the vehicle and second inspection data based on a result of inspection of the inspection apparatus, and transmits the feedback information to the vehicle. The present technology can be applied, for example, to a vehicle inspection system for inspecting a vehicle and so forth.

### TECHNICAL FIELD

The present technology relates to a management apparatus, a vehicle, an inspection apparatus, and a vehicle inspection system and an information processing method therefor, and particularly to a management apparatus, a vehicle, an inspection apparatus, and a vehicle inspection system and an information processing method therefor by which more efficient vehicle inspection can be implemented.

### BACKGROUND ART

A vehicle inspection registration system is provided for an automobile, and, in order to perform checking of whether or not an automobile complies with the security standard, it is necessary to have inspection performed for every fixed period. This inspection is commonly called vehicle inspection. It is considered that such vehicle inspection as just described will also be required in an autonomous driving society in the future.

However, in a vehicle in which a large number of advanced sensor devices or communication equipment are incorporated such as a self-driving vehicle, there is the possibility that sufficient inspection may not be performed in the current inspection period of once every few years. Further, it is supposed that, in the future, a self-driving vehicle is equipped with communication equipment and has a function of communicating with a network or another vehicle. For such a vehicle as just described, it is also expected to apply a more efficient and novel vehicle inspection system.

In a self-driving vehicle, since a large number of sensors, camera radars, and so forth are mounted, it becomes very important to confirm a vehicle body situation. Especially, in an autonomous driving society, since an automobile becomes the driving subject, the importance of confirmation of a vehicle body situation becomes high.

Further, there is a report that, basically, in self-driving, if even one vehicle that disturbs harmony exists, then the entire system is rendered instable. Therefore, it is desirable that only vehicles that satisfy certain fixed criteria in regard to all inspection parts are registered as self-driving vehicles, and any vehicle that does not satisfy any one of the fixed criteria must not be approved as a self-driving vehicle.

However, in the current vehicle inspection system, inspection for a large number of pieces of precision equipment in such self-driving environment as described above is not assumed and such a method that inspection is performed in a relatively long cycle is adopted. In such an inspection system for a long cycle as just described, there is the possibility that an unexpected failure of precision equipment may not be found on a real time basis and running on an autonomous driving lane for a long period of time in a state in which a problem remains may occur.

Therefore, a system in which vehicle inspection is performed on a more real time basis is required for equipment relating to self-driving such as a sensor or a camera radar.

In regard to detection of a vehicle state, for example, a vehicle information collection method that can collect and statistically process vehicle state information at present in detail on a real time basis and a system that utilizes the collected vehicle state information for calculation of insurance premiums are proposed (for example, refer to PTLS 1 and 2).

Further, in the current vehicle inspection, it is a common way to carry a vehicle to a vehicle inspection center such that an inspector performs inspection over a fixed period of time. Also an inspection status confirmation system which makes it possible for a user to know an situation of inspection by a maintenance technician on a real time basis is proposed (for example, refer to PTL 3). However, in a vehicle in which a large number of pieces of precision equipment are incorporated such as a self-driving vehicle, much time is required, and therefore, such a method as described above is not appropriate.

### CITATION LIST

### Patent Literature

### [PTL 1]

JP 2001-76012A

### [PTL 2]

JP 2001-76035A

### [PTL 3]

JP 2005-231377A

### SUMMARY

### Technical Problem

As described above, although the possibility that a new inspection method may be required for inspection of a vehicle in which a large number of pieces of precision equipment are incorporated such as a self-driving vehicle is high, such an inspection method as just described is yet to be established.

The present technology has been made in view of such a situation as described above and makes it possible to implement inspection of a vehicle with higher efficiency.

### Solution to Problem

A management apparatus of the first aspect of the present technology includes a decision unit configured to use first inspection data that is a result of inspection of an inspection target vehicle by the vehicle itself and second inspection data that is a result of inspection of the inspection target vehicle by a third party, to decide feedback information based on a result of determination obtained when a vehicle state of the inspection target vehicle is determined, and a communication unit configured to transmit the feedback information to the inspection target vehicle.

In the first aspect of the present technology, the first inspection data that is the result of inspection of the inspection target vehicle by the vehicle itself and the second inspection data that is the result of inspection of the inspection target vehicle by the third party are used to decide feedback information based on a result of determination obtained when a vehicle state of the inspection target vehicle is determined. Then, the feedback information is transmitted to the inspection target vehicle.

A vehicle of the second aspect of the present technology includes an inspection unit configured to inspect the vehicle itself that is an inspection target vehicle, and a communication unit configured to transmit first inspection data based on a result of the inspection by the inspection unit and receive feedback information based on a result of determination obtained when the vehicle state of the inspection target vehicle is determined using the first inspection data and second inspection data based on a result of inspection obtained when a third party other than the inspection target vehicle inspects the inspection target vehicle.

In the second aspect of the present technology, the vehicle itself that is an inspection target vehicle is inspected, and the first inspection data based on the result of the inspection is transmitted. Further, feedback information which is based on a result of determination obtained when the vehicle state of the inspection target vehicle is determined using the first inspection data and second inspection data based on a result of inspection obtained when a third party other than the inspection target vehicle inspects the inspection target vehicle is received.

An inspection apparatus of the third aspect of the present technology includes an inspection unit configured to inspect a vehicle as an inspection target vehicle, and a communication unit configured to transmit, to a determination apparatus that determines a vehicle state of the inspection target vehicle using first inspection data based on a result of inspection by the inspection target vehicle itself and second inspection data based on a result of the inspection by the inspection unit, the second inspection data.

In the third aspect of the present technology, the vehicle as the inspection target vehicle is inspected by the inspection unit, and to the determination apparatus that determines a vehicle state of the inspection target vehicle using first inspection data based on a result of inspection by the inspection target vehicle itself and second inspection data based on a result of the inspection by the inspection unit, the second inspection data is transmitted.

It is to be noted that the management apparatus of the first aspect and the inspection apparatus of the third aspect of the present technology can be implemented by a program executed by a computer. The program to be executed by the computer can be provided by transmission through a transmission medium or by recording on a recording medium.

A vehicle inspection system of the fourth aspect of the present technology includes a vehicle that is an inspection target vehicle, an inspection apparatus configured to inspect, as a third party, the vehicle, and a management apparatus configured to transmit feedback information based on a result of determination obtained when a vehicle state of the vehicle is determined using first inspection data from the vehicle and second inspection data from the inspection apparatus to the vehicle. The vehicle includes a first inspection unit configured to inspect the vehicle itself, and a first communication unit configured to transmit the first inspection data on the basis of a result of the inspection by the first inspection unit and receive the feedback information, the inspection apparatus includes a second inspection unit configured to inspect the vehicle, and a second communication unit configured to transmit the second inspection data on the basis of a result of the inspection by the second inspection unit, and the management apparatus includes a decision unit configured to decide the feedback information on the basis of the result of the determination, and a third communication unit configured to transmit the feedback information to the vehicle.

An information processing method for a vehicle inspection system of the fourth aspect of the present technology, in which the vehicle inspection system includes a vehicle that is an inspection target vehicle, an inspection apparatus configured to inspect, as a third party, the vehicle, and a management apparatus configured to transmit feedback information based on a result of determination obtained when a vehicle state of the vehicle is determined to the vehicle, includes inspecting, by the vehicle, the vehicle itself and transmitting first inspection data on the basis of a result of the inspection, inspecting, by the inspection apparatus, the vehicle and transmitting second inspection data on the basis of a result of the inspection, transmitting, by the management apparatus, the feedback information based on a result of determination obtained when the management apparatus determines a vehicle state of the vehicle using the first inspection data and the second inspection data, to the vehicle, and receiving, by the vehicle, the feedback information.

In the fourth aspect of the present technology, the vehicle that is an inspection target vehicle, the inspection apparatus that inspects, as a third party, the vehicle, and the management apparatus that transmits feedback information based on a result of determination obtained when a vehicle state of the vehicle is determined using first data from the vehicle and second inspection data from the inspection apparatus, are provided. The vehicle transmits first inspection data on the basis of a result of the inspection by the vehicle itself, and the inspection apparatus transmits second inspection data on the basis of a result of the inspection obtained when it inspects the vehicle. The management apparatus transmits the feedback information based on a result of determination obtained when the management apparatus determines a vehicle state of the vehicle using the first inspection data and the second inspection data to the vehicle, and the vehicle receives the feedback information.

The management apparatus and the inspection apparatus may each be an independent apparatus or may be an internal block configuring one apparatus.

### Advantage Effect of Invention

With the first to third aspects of the present technology, more efficient inspection of a vehicle can be implemented.

With the fourth aspect of the present technology, a vehicle can be inspected more efficiently.

It is to be noted that the advantageous effects described here are not necessarily restrictive, and other advantageous effects described in the present disclosure may be applicable.

### BRIEF DESCRIPTION OF DRAWINGS

FIG. 1 is a block diagram depicting an example of a configuration of an embodiment of a vehicle inspection system to which the present technology is applied.

FIG. 2 is a view depicting an example in which an inspection section is set to a passage section of a road.

FIG. 3 is a flow chart illustrating an inspection process of the vehicle inspection system of FIG. 1.

FIG. 4 is a flow chart illustrating a first particular example of the inspection process.

FIG. 5 is a flow chart illustrating a second particular example of the inspection process.

FIG. 6 is a view illustrating an example of image sensor inspection.

FIG. 7 is a flow chart illustrating a third particular example of the inspection process.

FIG. 8 is a view depicting an example of a configuration of a vehicle of FIG. 1.

FIG. 9 is a block diagram depicting an example of a configuration of a determination apparatus, a management apparatus, or a server apparatus as a notification destination apparatus of FIG. 1.

### DESCRIPTION OF EMBODIMENT

In the following, a mode for carrying out the present technology (hereinafter referred to as embodiment) is described. It is to be noted that the description is given in the following order.

1. Example of Configuration of Vehicle Inspection System

2. Inspection Process of Vehicle Inspection System

3. First Particular Example of Inspection Process

4. Second Particular Example of Inspection Process

5. Third Particular Example of Inspection Process

6. Example of Configuration of Vehicle

7. Example of Configuration of Server Apparatus

### <1. Example of Configuration of Vehicle Inspection System>

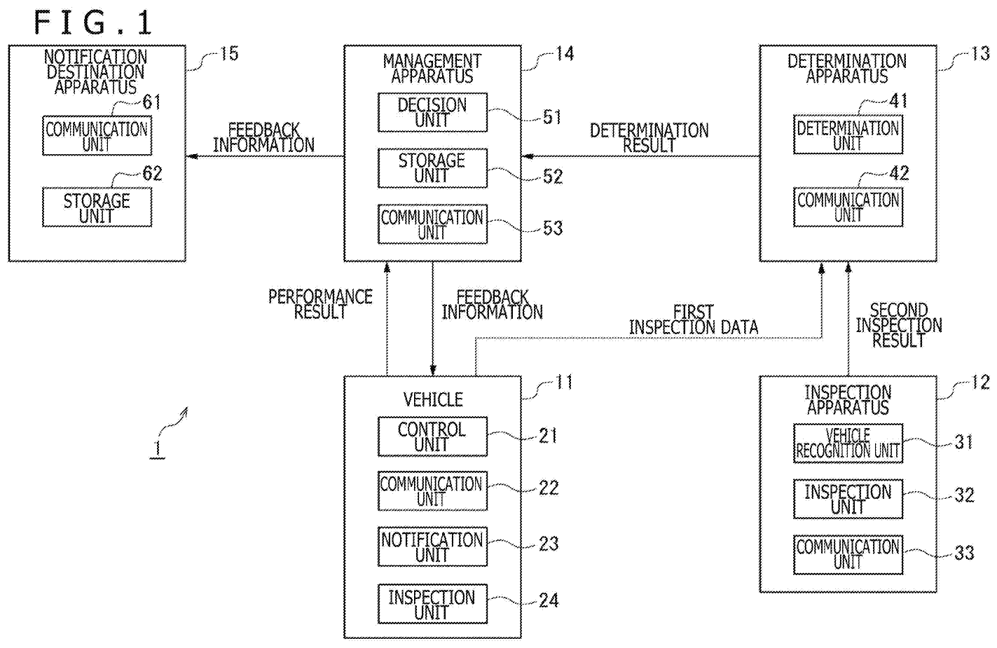

FIG. 1 is a block diagram depicting an example of a configuration of an embodiment of a vehicle inspection system to which the present technology is applied.

A vehicle inspection system 1 of FIG. 1 includes a vehicle 11, an inspection apparatus 12, a determination apparatus 13, a management apparatus 14, and a notification destination apparatus 15. The vehicle inspection system 1 is a system that inspects a vehicle state of the vehicle 11 that is an inspection target vehicle and feeds back a result of the inspection to the vehicle 11. It is to be noted that inspection of a vehicle state is performed at a motor vehicle inspection and registration place set in advance such as a predetermined inspection section set in advance on a road, a vehicle inspection center, or a gas station.

### (Vehicle 11)

The vehicle 11 is, for example, a self-propelled vehicle body such as an automobile, an electric automobile, a hybrid electric automobile or a motorcycle. The present embodiment is described in regard to an example in which the vehicle 11 is an automobile, as a representative example. The vehicle 11 requires periodic inspection for safe running, and the vehicle state of it is inspected by the vehicle inspection system 1.

The vehicle 11 at least includes a control unit 21, a communication unit 22, a notification unit 23, and an inspection unit 24.

In the case where the vehicle 11 arrives at a predetermined motor vehicle inspection and registration place, it inspects (self-diagnoses) the vehicle state of the vehicle 11 itself and transmits inspection data of a result of the inspection to the determination apparatus 13. For example, in the case where the motor vehicle inspection and registration place is a predetermined inspection section set in advance on a road, the vehicle 11 recognizes from an RSU (Road Side Unit) by road-vehicle communication such as DSRC (Dedicated Short Range Communication) that the place is an inspection section, and starts inspection. On other hand, in the case where the motor vehicle inspection and registration place is a vehicle inspection center, a gas station, or the like, a control signal for starting inspection is transmitted from a predetermined communication apparatus to the vehicle 11 to start inspection.

It is to be noted that, in the following description, inspection data of a result of inspection by the vehicle 11 itself is referred to as first inspection data so as to distinguish the same from inspection data that is a result of inspection by the inspection apparatus 12.

Further, in the case where the vehicle 11 receives feedback information transmitted thereto from the management apparatus 14, on the basis of the first inspection data transmitted therefrom, and performs a predetermined process or work in response to the feedback information, the vehicle 11 transmits a result of the performance to the management apparatus 14.

The control unit 21 includes a vehicle controlling ECU (Electronic Control Unit) or the like and controls operation of the entire vehicle 11. For example, when first inspection data is generated by the inspection unit 24, the control unit 21 controls the communication unit 22 to transmit the first inspection data to the determination apparatus 13. Further, for example, when feedback information is transmitted from the management apparatus 14, the control unit 21 supplies the feedback information to the notification unit 23 and controls the notification unit 23 to execute a process of notifying the user of the feedback information.

The communication unit 22 performs communication between units in the vehicle 11 and communication with a different apparatus such as the determination apparatus 13 or the management apparatus 14 through various networks including an in-vehicle communication network that complies with any standard such as CAN (Controller Area Network), LIN (Local Interconnect Network), MOST (Media Oriented Systems Transport), FlexRay (registered trademark), or Ethernet (registered trademark), a telephone network, a satellite communication network, and the Internet.

For example, the communication unit 22 transmits first inspection data to the determination apparatus 13 and receives feedback information from the management apparatus 14 under the control of the control unit 21. Further, the communication unit 22 transmits a performance result obtained when a predetermined process or work is performed in response to feedback information, to the management apparatus 14.

The notification unit 23 includes, for example, a liquid crystal display, an instrument panel, a speaker, and so forth and notifies the user of predetermined information through sound or an image, under the control of the control unit 21. For example, the notification unit 23 displays feedback information transmitted thereto from the management apparatus 14 on a display unit including a liquid crystal display, and outputs the feedback information in sound from the speaker.

The inspection unit 24 inspects a vehicle state of the vehicle 11 and outputs first inspection data that is a result of the inspection. The inspection unit 24 includes one of or both various sensors provided on the vehicle 11 and an information processing unit that executes a predetermined state determination process using data outputted from the sensors.

The first inspection data may be measurement data itself measured by the various sensors or may be a determination result such as OK or NG based on a result of measurement or a quantized value such as a diagnosis level determined on a scale of 1 to 10.

For example, as the various sensors that can be adopted as the inspection unit 24, the following sensors mounted on the vehicle 11 are available.

A. Environment recognizing sensors
Radar
LIDAR
Image sensor
Infrared sensor

B. Engine controlling system sensors
Airflow meter
Vacuum sensor
O2 sensor
A/F sensor
Throttle position sensor
Crank position sensor
Cam position sensor
Engine controlling temperature sensor
Knock sensor
Accelerator position sensor

C. Chassis controlling system sensors
Steering sensor
Height control sensor
Wheel speed sensor
Yaw rate sensor
Oil temperature sensor
Electric power steering torque sensor

D. Safe-comfort controlling system sensor
Airbag sensor
Ultrasonic sensor
Tire air pressure sensor
Radar sensor
Touch sensor
Auto light sensor
Auto air conditioner sensor
Liquid level sensor
Lane sensor
Exhaust gas detection sensor
Alcohol interlocking sensor

E. Communication system sensor
Navigation system angular velocity sensor (gyro sensor)

Further, as the items of inspection to be performed by the inspection unit 24, the following items are available.
Tire wear situation
Vehicle body exterior situation (scratch, dent, crack, or the like of the vehicle body)
Driver and passenger situation

A situation of passengers such as face recognition information, a drinking state, whether or not a seat belt is used and a mounting state of the seat belt, or a consciousness level is detected through use of information obtained from an HMI (Human Machine Interface) and so forth.
Lamps (headlamp, lamp), direction indicator, and hazard situation
State of wiper and washer fluid
State of warning lamp viewed from the driver's seat
Whether or not a baby seat is used and mounting state of the baby seat
Vehicle body weight

It is estimated from the vehicle body weight whether or not a suspicious thing is loaded.
Insurance status
Driver scoring status

For example, driver safety and so forth are scored from an accident history, driving roughness and so forth. The driver scoring status may be decided by artificial intelligence (AI).
Side slip situation
Foot brake situation
Parking brake situation
Speedometer operating condition
Components of exhaust gas
Presence/absence of a smoke candle
Engine oil viscosity, quantity
Cooling water quantity
Leakage from the radiator hose

The communication unit 22 of the vehicle 11 transmits first inspection data to the determination apparatus 13 together with vehicle identification information for identifying the vehicle 11. As the vehicle identification information, for example, the number of the vehicle 11, the chassis number, license information of the driver (at least including the driver's license number), information of the automobile inspection certificate (vehicle inspection certificate), and so forth can be adopted. The vehicle identification information may include vehicle information such as a sensor device, a function, and a property the vehicle 11 has.

Further, the communication unit 22 of the vehicle 11 may transmit the first inspection data including, as additional information, information relating to a situation when the inspection was performed (hereinafter referred to as vehicle inspection situation information), to the determination apparatus 13. The vehicle inspection situation information may include, for example, position information of the place at which the inspection was performed, time at which the inspection was performed, inspection target, number of times of inspection, temperature, humidity, or weather of the environment when the inspection was performed, information indicative of the motor vehicle inspection and registration place, information indicative of the inspection section, and so forth.

Further, the communication unit 22 of the vehicle 11 may transmit first inspection data including, as additional information, inspection history information relating to the inspection in the past, feedback history information relating to feedback information in the past, and so forth, to the determination apparatus 13.

### (Inspection Apparatus 12)

The inspection apparatus 12 inspects the vehicle state of the vehicle 11 that is an inspection target vehicle and transmits inspection data that is a result of the inspection to the determination apparatus 13. The data of inspection by the inspection apparatus 12 is referred to as second inspection data in order to distinguish the same from data of inspection by the vehicle 11 itself (first inspection data).

It is sufficient if the inspection apparatus 12 is an apparatus as a third party other than the inspection target vehicle, and the inspection apparatus 12 may possibly be infrastructure equipment or a vehicle that includes at least the following functions.

As the infrastructure equipment that may possibly be the inspection apparatus 12, for example, the following items are applicable.
RSU (Road Side Unit)
Traffic light
Guardrail
Curb
Asphalt
Sign
Telephone pole
ETC
Commercial facility

For example, a car wash machine, a gas station, a vehicle inspection center, and so forth.

A vehicle that can become the inspection apparatus 12 is, for example, a peripheral vehicle such as an automobile that runs parallel to the inspection target vehicle at the front, rear, left, or right, a police vehicle, and a special vehicle such as a fire truck. It is necessary to authenticate and register a vehicle, which is to be made the inspection apparatus 12, as a vehicle that includes functions and equipment as the inspection apparatus 12.

The inspection apparatus 12 includes at least a vehicle recognition unit 31, an inspection unit 32, and a communication unit 33.

The vehicle recognition unit 31 recognizes the vehicle 11 that is an inspection target vehicle and causes the inspection unit 32 to start inspection. For example, in the case where the inspection apparatus 12 is a piece of infrastructure equipment such as an RSU or a traffic light installed beside a road, the vehicle recognition unit 31 recognizes approach of the vehicle 11 through inter-vehicle communication with the vehicle 11.

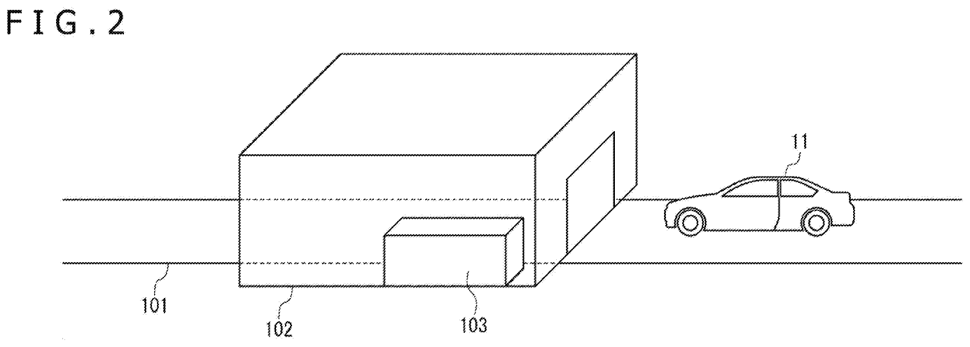

FIG. 2 depicts an example in which the inspection apparatus 12 is an RSU installed beside a road and an inspection section is set to a passage section of the road.

An RSU 103 as the inspection apparatus 12 installed beside a road 101 causes the inspection unit 32 to start inspection in the case where it detects approach of the vehicle 11 passing an inspection section 102 set to the road 101 by road-vehicle communication. It is to be noted that the inspection section 102 of FIG. 2 is an example in which it is visualized and illustrated for description, and in reality, objects in a visible state as depicted in FIG. 2 are not set.

Further, in the case where the inspection apparatus 12 is a piece of commercial facility such as a car wash machine or a vehicle inspection center, the vehicle recognition unit 31 recognizes the vehicle 11 from a control signal for starting inspection from a predetermined communication apparatus or in response to a result of detection of the vehicle 11 by an image sensor, and causes the inspection unit 32 to start inspection.

The inspection unit 32 inspects the vehicle state of the vehicle 11 and outputs second inspection data that is a result of the inspection. Similarly to the inspection unit 24 of the vehicle 11, the inspection unit 32 includes various sensors such as environment recognizing sensors, engine controlling system sensors, chassis controlling system sensors, safe-comfort controlling system sensors, and communication system sensors and a gravimeter, and can inspect items same as the items of inspection performed by the inspection unit 24 of the vehicle 11. However, the items of inspection performed by the inspection unit 32 and the items of inspection performed by the inspection unit 24 of the vehicle 11 are not necessarily required to be coincident with each other.

The communication unit 33 performs communication for inspection with a unit in the vehicle 11 and performs communication with the determination apparatus 13 through various networks including an in-vehicle communication network that complies with any standard such as CAN, LIN, MOST, FlexRay (registered trademark), or Ethernet (registered trademark), a telephone network, a satellite communication network, and the Internet. For example, the communication unit 33 transmits second inspection data to the determination apparatus 13 through the network.

The communication unit 33 transmits second inspection data to the determination apparatus 13 together with vehicle identification information for identifying the vehicle 11 that is an inspection target vehicle. The vehicle identification information is the number of the vehicle 11, the chassis number, license information of the driver (at least including the driver's license number), information of the vehicle inspection certificate (vehicle inspection certificate), and so forth, similarly to those described hereinabove.

Further, the communication unit 33 may transmit second inspection data including, as additional information, information relating to a situation when the inspection is performed (vehicle inspection situation information), to the determination apparatus 13. As the vehicle inspection situation information, for example, inspection apparatus identification information for identifying the inspection apparatus 12, position information of the place at which the inspection is performed, time at which the inspection is performed, inspection target, number of times of inspection, temperature, humidity, or weather of the environment when the inspection is performed, information indicative of the motor vehicle inspection and registration place, information indicative of the inspection section, and so forth are available.

Furthermore, the communication unit 33 may transmit second inspection data including, as additional information, inspection history information relating to the inspection in the past, feedback history information relating to feedback information in the past, and so forth, to the determination apparatus 13.

It is to be noted that, although it is described in the description of the present embodiment that, except the vehicle 11 that is an inspection target vehicle, one inspection apparatus 12 performs inspection which is the same as the inspection performed by the vehicle 11, a plurality of inspection apparatuses 12 may perform inspection. For example, each of two vehicles running beside the vehicle 11 may be used as the inspection apparatus 12 and perform inspection.

### (Determination Apparatus 13)

The determination apparatus 13 determines a vehicle state of the vehicle 11 using first inspection data transmitted from the vehicle 11 that is an inspection target vehicle and second inspection data transmitted from the inspection apparatus 12 that is a third party to the vehicle 11.

The determination apparatus 13 includes, for example, a server apparatus (cloud server), a piece of infrastructure facility that can become the inspection apparatus 12, a vehicle, or the like, and includes at least a determination unit 41 and a communication unit 42. The determination apparatus 13 may be configured in an integrated relationship with one or more of the vehicle 11, the inspection apparatus 12, or the management apparatus 14.

The determination unit 41 determines a vehicle state of the vehicle 11 using first inspection data and second inspection data.

The communication unit 42 performs predetermined communication with the vehicle 11, the inspection apparatus 12, and the management apparatus 14 through various networks including an in-vehicle communication network that complies with any standard such as CAN, LIN, MOST, FlexRay (registered trademark), or Ethernet (registered trademark), a telephone network, a satellite communication network, and the Internet.

In particular, the communication unit 42 receives first inspection data from the vehicle 11 and receives second inspection data from the inspection apparatus 12. Further, the communication unit 42 transmits a result of determination of the determination unit 41 to the management apparatus 14.

The communication unit 42 transmits a result of determination of the determination unit 41 to the management apparatus 14 together with vehicle identification information for identifying the vehicle 11 that is an inspection target vehicle. The vehicle identification information is the number of the vehicle 11, the chassis number, license information of the driver (at least including the driver's license number), information of the vehicle inspection certificate (vehicle inspection certificate), and so forth, similarly to those described above.

Further, in the case where vehicle inspection situation information, inspection history information, feedback history information, or the like of the vehicle 11 is transmitted from the vehicle 11 or the inspection apparatus 12 to the communication unit 42, the communication unit 42 may include them as additional information into a result of the determination and transmit the same to the management apparatus 14.

### (Management Apparatus 14)

The management apparatus 14 decides and generates feedback information and decides a notification destination of the feedback information, on the basis of a determination result of the vehicle state of the vehicle 11 transmitted thereto from the determination apparatus 13. Then, the management apparatus 14 transmits the generated feedback information to the decided notification destination. The notification destination is at least one of the vehicle 11 or the notification destination apparatus 15, and for the vehicle 11, a notification destination may further be set in detail, such as a predetermined control unit. The notification destination apparatus 15 is a server apparatus (communication apparatus) of a public authority (police, fire department, or the like), an owner of the vehicle, or an insurance company recorded in advance.

Further, the management apparatus 14 stores the generated feedback information into an internal database such that it updates, in the case where a performance result of feedback is transmitted thereto from the vehicle 11, the feedback information stored therein, on the basis of the feedback information transmitted to the vehicle 11.

The management apparatus 14 includes, for example, a server apparatus (cloud server), a piece of infrastructure facility that can become the inspection apparatus 12, a vehicle, or the like, and includes at least a decision unit 51, a storage unit 52 and a communication unit 53. The management apparatus 14 may be configured in an integrated relationship with one or more of the vehicle 11, the inspection apparatus 12, or the determination apparatus 13.

The decision unit 51 decides and generates feedback information and decides a notification destination of the feedback information, on the basis of a determination result transmitted thereto from the determination apparatus 13. The generated feedback information and notification destination are stored into the storage unit 52 together with the received determination result.

The decision unit 51 generates improvement instruction information for the vehicle 11 as feedback information whose notification destination is the vehicle 11. For example, the decision unit 51 generates, as the improvement instruction information, information indicative of a determination result of “NG” of a predetermined part or device in the vehicle 11, information of the instruction for requesting exchange of a predetermined part or device, information of an instruction for requesting repair of the vehicle body, or the like. The improvement instruction information for the vehicle 11 is supplied, for example, to the notification unit 23 of the vehicle 11 and is displayed on a liquid crystal display or the instrument panel or outputted in sound from a speaker.

Further, for example, the decision unit 51 generates control information for remotely controlling the vehicle 11, as feedback information whose notification destination is the vehicle 11. In the case where running of the vehicle 11 is dangerous, the decision unit 51 remotely controls the vehicle 11 such that the vehicle 11 is stopped (emergently stopped) on a roadside belt or is isolated into a lane exclusively used for withdraw. For example, control information for remotely controlling the vehicle 11 such that transition of an operation mode from a manual operation mode to an automatic operation mode is disabled may be generated as the feedback information.

On the other hand, in the case where the improvement instruction information is information of an instruction for updating of software, such remote control as to perform update of software may be executed.

In the case where a driver who drives the vehicle 11 is to be secured, such remote control as to lock the door of the vehicle 11 may be performed. Further, in the case where the vehicle 11 is to be emergently stopped, caltrops may be scattered from infrastructure equipment.

The decision unit 51 transmits, as the feedback information whose notification destination is the notification destination apparatus 15, information which is the same as the information to be transmitted to the vehicle 11, except control information for remotely controlling the vehicle 11.

Further, in the case where a performance result obtained when a predetermined process is performed on the basis of feedback information is transmitted to the decision unit 51 from the vehicle 11, the decision unit 51 updates the feedback information stored in the storage unit 52. In the case where the feedback information is updated, the updated feedback information may be transmitted to the notification destination apparatus 15 again.

Furthermore, the decision unit 51 may otherwise generate and add feedback auxiliary information to the feedback information so as to be transmitted to the vehicle 11 or the notification destination apparatus 15.

The feedback auxiliary information may include, for example, performance time information representative of performance time at which the inspection of the vehicle state is performed, performance deadline information representative of a performance deadline of improvement items indicated by feedback information, a feedback level representative of importance (weight) of the feedback information or each improvement item, and so forth. The feedback level defines such that, as the level becomes higher, the mandatory power for causing the item of improvement to be performed becomes stronger. Information of a determination result itself received from the determination apparatus 13 may be transmitted as the feedback auxiliary information.

The storage unit 52 stores a determination result received from the determination apparatus 13 and feedback information and a notification destination decided and generated by the decision unit 51 for each vehicle 11 that is an inspection target vehicle.

The communication unit 53 performs predetermined communication with the vehicle 11, the determination apparatus 13, and the notification destination apparatus 15 through various networks including an in-vehicle communication network that complies with any standard such as CAN, LIN, MOST, FlexRay (registered trademark), or Ethernet (registered trademark), a telephone network, a satellite communication network, and the Internet. For example, the communication unit 53 transmits feedback information to the vehicle 11 and receives a performance result of the feedback from the vehicle 11. Further, the communication unit 53 transmits the feedback information to the notification destination apparatus 15.

### (Notification Destination Apparatus 15)

The notification destination apparatus 15 includes a communication unit 61 and a storage unit 62 and stores feedback information transmitted thereto from the management apparatus 14. As described above, the notification destination apparatus 15 includes a server apparatus (communication apparatus) of a public authority (police, fire department, or the like), an owner of the vehicle, or an insurance company recorded in advance.

The communication unit 61 performs predetermined communication with the management apparatus 14 through various networks including an in-vehicle communication network that complies with any standard such as CAN, LIN, MOST, FlexRay (registered trademark), or Ethernet (registered trademark), a telephone network, a satellite communication network, and the Internet. In particular, the communication unit 61 receives feedback information from the management apparatus 14 and supplies the feedback information to the storage unit 62.

The storage unit 62 stores feedback information transmitted thereto from the management apparatus 14.

For example, in the case where the notification destination apparatus 15 is a server apparatus of an insurance company, the insurance company will use feedback information of the vehicle 11 stored in the storage unit 62 for calculation of next insurance premiums for the vehicle 11.

For example, in the case where the notification destination apparatus 15 is a server apparatus of a police, the police will instruct the owner of the vehicle 11 to improve a failure of the vehicle 11, on the basis of the feedback information of the vehicle 11 stored in the storage unit 62.

### <2. Inspection Process of Vehicle Inspection System>

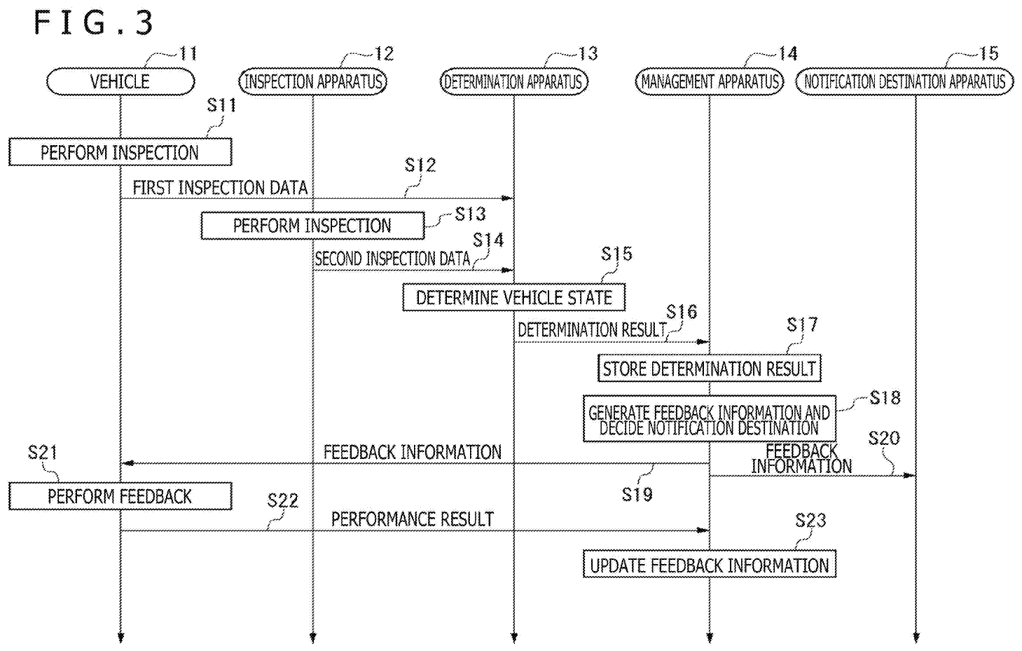

Now, an inspection process of the vehicle inspection system 1 is described with reference to a flow chart of FIG. 3. This process is started, for example, when a vehicle 11 that is an inspection target vehicle passes a predetermined inspection section on a road set as a motor vehicle inspection and registration place.

First, in step S11, the vehicle 11 performs inspection of the vehicle state of the vehicle 11 itself, and in step S12, the vehicle 11 transmits first inspection data that is a result of the inspection to the determination apparatus 13 together with vehicle identification information for identifying the vehicle 11. The vehicle identification information is, for example, the number, the chassis number or the like of the vehicle 11. The first inspection data can be transmitted including, as additional information, at least one of vehicle inspection situation information, inspection history information, and feedback history information of the vehicle 11, to the determination apparatus 13.

In step S13, the inspection apparatus 12 performs inspection of the vehicle state of the vehicle 11 that is the inspection target vehicle, and in step S14, the inspection apparatus 12 transmits second inspection data that is a result of the inspection to the determination apparatus 13 together with the vehicle identification information for identifying the vehicle 11. The second inspection data can be transmitted including, as additional information, at least one of vehicle inspection situation information, inspection history information, or feedback history information of the vehicle 11 to the determination apparatus 13.

The processes in steps S11 and S12 executed by the vehicle 11 and the processes in steps S13 and S14 executed by the inspection apparatus 12 may be executed in any order of processing and may be executed simultaneously.

In step S15, the determination apparatus 13 determines the vehicle state of the vehicle 11 using the first inspection data transmitted thereto from the vehicle 11 and the second inspection data transmitted thereto from the inspection apparatus 12, and in step S16, the determination apparatus 13 transmits a result of the determination to the management apparatus 14 together with the vehicle identification information for identifying the vehicle 11. The determination result can be transmitted including, as additional information, the vehicle inspection situation, inspection performance situation information, feedback history information, or the like of the vehicle 11 transmitted from the vehicle 11 or the inspection apparatus 12, to the management apparatus 14. The vehicle inspection situations, inspection performance situation information, feedback history information, or the like of both the vehicle 11 and the inspection apparatus 12 may be included as additional information into and transmitted together with the determination result to the management apparatus 14.

In step S17, the management apparatus 14 receives and stores into the storage unit 52 the determination result of the vehicle state of the vehicle 11 transmitted thereto from the determination apparatus 13. Then, in step S18, the management apparatus 14 generates feedback information on the basis of the received determination result and decides a notification destination of the feedback information. The generated feedback information and the notification destination are stored in an associated relationship with the determination result of the vehicle 11 into the storage unit 52. The feedback information generated here is, for example, improvement instruction information for the vehicle 11, control information for remotely controlling the vehicle 11, and so forth.

In step S19, the management apparatus 14 transmits the generated feedback information to a predetermined unit of the vehicle 11 decided as a notification destination. In step S20, the management apparatus 14 transmits the generated feedback information to the notification destination apparatus 15 decided as the notification destination. The processes in step S19 and S20 may be reversed in order or may be performed at the same time. The feedback information to be transmitted to the vehicle 11 and the feedback information to be transmitted to the notification destination apparatus 15 may be the same with each other or may be different from each other.

It is to be noted that the management apparatus 14 may otherwise generate and add feedback auxiliary information to the feedback information so as to be transmitted to the vehicle 11 or the notification destination apparatus 15. The feedback auxiliary information may be, for example, inspection performance time information, performance deadline information of improvement items, importance (weight) of the feedback information or each improvement item, and so forth.

In step S21, the vehicle 11 receives the feedback information transmitted thereto from the management apparatus 14 and performs feedback. In particular, the vehicle 11 performs a predetermined process or work based on the feedback information. Then, in step S22, the vehicle 11 transmits a performance result obtained when the predetermined process or work is performed in response to the feedback information, to the management apparatus 14.

In step S23, the management apparatus 14 receives the performance result transmitted thereto from the vehicle 11 and updates the feedback information stored in the storage unit 52. As the update of the feedback information, for example, performance of the improvement items for the vehicle 11 is additionally stored into a part corresponding to the feedback information of the vehicle 11 stored in the storage unit 52. The update information of the feedback information may be transmitted to the notification destination apparatus 15.

The inspection process of the vehicle inspection system 1 is executed in such a manner as described above.

In the following, the inspection process is described particularly taking some of specific inspection items as an example in order to facilitate understanding of the inspection process of the vehicle inspection system 1 described above with reference to FIG. 3.

### <3. First Particular Example of Inspection Process>

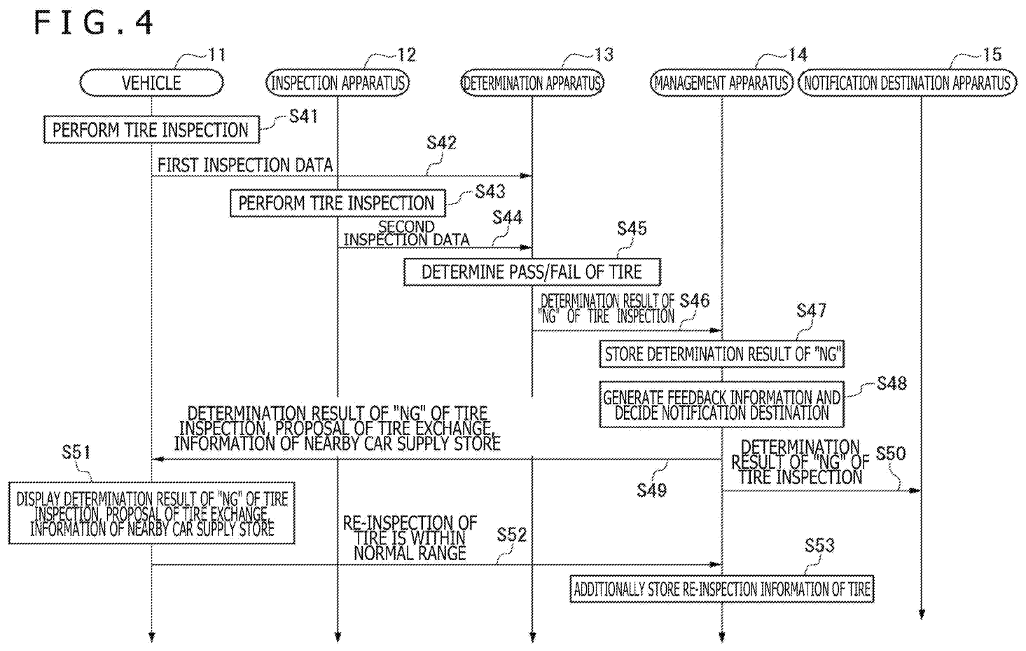

First, an example of the inspection process relating to tire inspection is described with reference to a flow chart of FIG. 4. The example of FIG. 4 described below is directed to a case in which the inspection apparatus 12 and the determination apparatus 13 are configured as one RSU and the management apparatus 14 is configured from a cloud server (server apparatus).

First, in step S41, the vehicle 11 performs tire inspection. In particular, the vehicle 11 performs measurement of the air pressure inside the tire and wear inspection of the tire surface. The air pressure is, for example, acquired as air pressure information from a device inserted in the inside of the tire. Meanwhile, the wear situation of the tire surface is, for example, determined from an image of the tire surface captured by an image sensor installed in the proximity of the tire.

In step S42, the vehicle 11 transmits a result of the tire inspection as first inspection data to the RSU as the determination apparatus 13 together with the vehicle identification information. In this example, the data of the air pressure itself and a result of the determination of the wear situation are transmitted as the first inspection data to the RSU as the determination apparatus 13.

In step S43, the RSU that is the inspection apparatus 12 performs tire inspection of the vehicle 11. In particular, the inspection apparatus 12 measures (predicts) the air pressure in the inside of the tire from the wear situation of the tire and the depression of the tire in the image captured by the image sensor of the inspection apparatus 12 itself to perform wear inspection of the tire surface.

In step S44, the inspection apparatus 12 transmits a result of the tire inspection as second inspection data to the RSU as the determination apparatus 13 together with the vehicle identification information. In this example, since the inspection apparatus 12 and the determination apparatus 13 are configured from the same RSU, the result of the tire inspection as the second inspection data is retained in the RSU.

In step S45, the RSU that is the determination apparatus 13 uses the first inspection data transmitted from the vehicle 11 and the second inspection data by the inspection apparatus 12 to determine pass/fail of the tire inspection, and in step S46, the RSU transmits a result of the determination to the cloud server as the management apparatus 14 together with the vehicle identification information for identifying the vehicle 11. In this example, it is assumed that, as the determination result of the tire inspection, “NG” is determined from between “OK” and “NG” because the air pressure of the tire is insufficient.

In step S47, the cloud server that is the management apparatus 14 receives the determination result of “NG” of the tire inspection transmitted from the RSU as the determination apparatus 13 and stores the determination result of “NG” into the storage unit 52. Then, in step S48, the management apparatus 14 generates feedback information and decides notification destinations of the feedback information on the basis of the determination result of “NG” of the tire inspection.

In this example, the vehicle 11 is decided as one of the notification destinations, and such information that the determination result of the tire inspection is “NG,” a proposal of tire exchange, and information of a nearby car supply store are decided and generated as feedback information for the vehicle 11. A server apparatus of a police as the notification destination apparatus 15 is decided as another one of the notification destinations, and such information that the determination result of “NG” of the tire inspection has been generated in the inspection of the vehicle state of the vehicle 11 is decided and generated as feedback information to the server apparatus of the police.

In step S49, the management apparatus 14 transmits the generated feedback information to a predetermined unit of the vehicle 11 decided as the notification destination. In particular, the cloud server that is the management apparatus 14 transmits such information that the determination result of the tire inspection is “NG,” the proposal of tire exchange, and the information of a nearby car supply store to the notification unit 23 of the vehicle 11.

In step S50, the management apparatus 14 transmits the generated feedback information for the notification destination apparatus 15 decided as the notification destination. In particular, as the feedback information, such information that the determination result of “NG” of the tire inspection has been generated in the inspection of the vehicle state of the vehicle 11 is transmitted and stored into the server apparatus of the police as the notification destination apparatus 15.

In step S51, the vehicle 11 receives the feedback information transmitted thereto from the management apparatus 14 and performs feedback. In particular, the liquid crystal display that is the notification unit 23 of the vehicle 11 displays that the determination result of the inspection result is “NG,” the proposal of tire exchange, and the information of a nearby car supply store. The driver of the vehicle 11 would look at the information displayed on the notification unit 23 and drop in at the nearby car supply store to cause tire exchange to be performed.

Then, in step S52, the vehicle 11 transmits a performance result obtained when a predetermined process or work is performed in response to the feedback information, to the management apparatus 14. For example, after the tire exchange is performed, the driver of the vehicle 11 would select the item for tire re-inspection displayed on the display such that the vehicle 11 performs tire re-inspection. The vehicle 11 performs re-inspection of the tire and detects that a result of measurement of the air pressure in the inside of the tire and a result of wear inspection of the tire surface remain within normal ranges, and transmits a result of the detection as a performance result to the management apparatus 14.

In step S53, the management apparatus 14 receives the performance result transmitted thereto from the vehicle 11 and updates the feedback information stored in the storage unit 52. In this example, the management apparatus 14 additionally stores into a part in the storage unit 52 corresponding to the feedback information of the vehicle 11 that re-inspection of the tire has been performed and the inspection results are within the normal ranges.

As described above, according to the first particular example of the inspection process, pass/fail is determined using an inspection result (first inspection data) of tire inspection by the vehicle 11 itself that is an inspection target vehicle and an inspection result (second inspection data) of tire inspection by the RSU as the inspection apparatus 12 that is a third party and the determination apparatus 13, and feedback information is decided and generated on the basis of a result of the determination and transmitted to the vehicle 11 and the notification destination apparatus 15. In the vehicle 11, feedback is performed and the feedback information of the management apparatus 14 is also updated, on the basis of the feedback information.

### <4. Second Particular Example of Inspection Process>

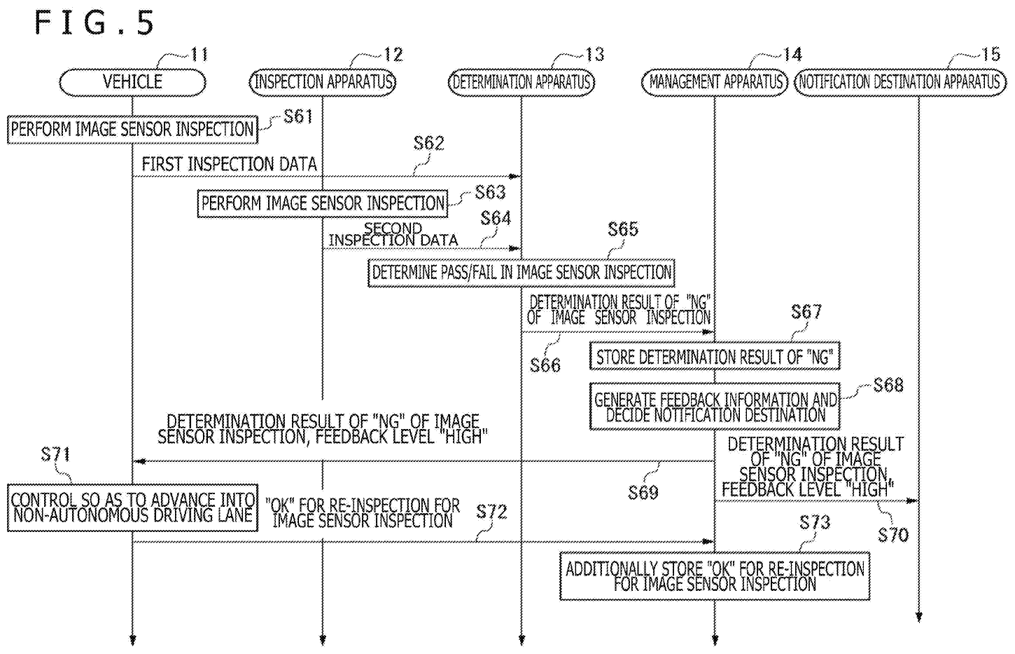

Now, an example of an inspection process relating to image sensor inspection for inspecting an image sensor that is one of the sensor devices is described with reference to a flow chart of FIG. 5.

The example of FIG. 5 described below is directed to a case in which the inspection apparatus 12 is configured from a different vehicle that runs in the proximity of the vehicle 11 as an inspection target vehicle and the determination apparatus 13 is configured from an RSU while the management apparatus 14 is configured from a cloud server (server apparatus).

Further, the example of FIG. 5 is an example of an inspection process when the vehicle 11 as an inspection target vehicle passes a predetermined inspection section set as a motor vehicle inspection and registration place at an entrance of an express way. It is assumed that the express way after the inspection section is passed includes an autonomous driving lane on which running by fully automatic operation is to be performed and a non-autonomous driving lane on which running by fully automatic operation is not to be performed.

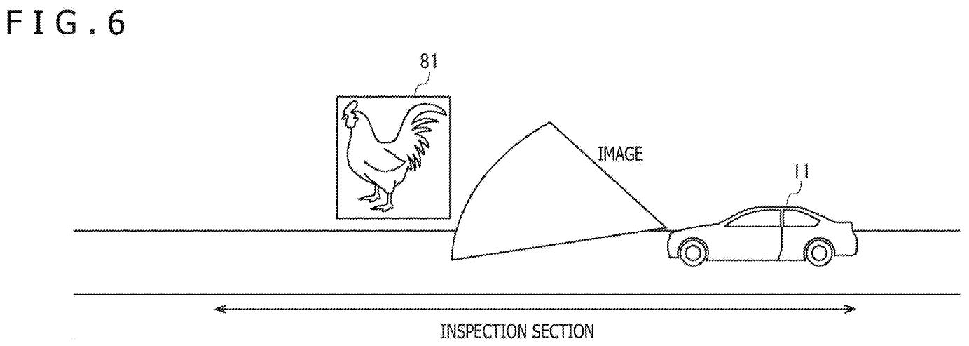

First, in step S61, the vehicle 11 performs image sensor inspection. In particular, the vehicle 11 images a reference 81 that is an imaging target for inspection installed in the inspection section in advance, as depicted in FIG. 6.

In step S62, the vehicle 11 transmits an image that captures the reference 81 as first inspection data to the RSU as the determination apparatus 13 together with the vehicle identification information.

In step S63, a different vehicle, as the inspection apparatus 12, running in the proximity of the vehicle 11 performs image sensor inspection of the vehicle 11. In particular, the inspection apparatus 12 images the image sensor of the vehicle 11 using the image sensor of the inspection apparatus 12 itself and decides whether or not the lens of the image sensor of the vehicle 11 has some scratch. In this case, the inspection apparatus 12 may output an instruction to the vehicle 11 to run at a speed which is the same as that of the inspection apparatus 12 to control such that image sensor inspection to be performed by the inspection apparatus 12 is facilitated.

In step S64, the different vehicle as the inspection apparatus 12 transmits a result of the image sensor inspection, particularly whether or not the lens of the image sensor of the vehicle 11 has some scratch, as second inspection data to the RSU as the determination apparatus 13 together with the vehicle identification information.

In step S65, the determination apparatus 13 determines pass/fail of the image sensor inspection using the first inspection data transmitted thereto from the vehicle 11 and the second inspection data transmitted thereto from the inspection apparatus 12. Then, in step S66, the determination apparatus 13 transmits a result of the determination to the cloud server as the management apparatus 14 together with the vehicle identification information for identifying the vehicle 11. In the present example, it is assumed that, although the determination result of the determination of whether or not the lens has some scratch is “OK,” the state of the image capturing the reference 81 is decided as “NG” and, as a result of the determination of the entire image sensor inspection, determination of “NG” is made.

In step S67, the cloud server that is the management apparatus 14 receives the determination result of “NG” of the image sensor inspection transmitted thereto from the RSU as the determination apparatus 13, and stores the determination result of “NG” into the storage unit 52. Then, in step S68, the management apparatus 14 generates feedback information and decides notification destinations of the feedback information on the basis of the determination result of “NG” of the image sensor inspection.

In this example, the vehicle 11 is decided as one of the notification destinations and, as the feedback information for the vehicle 11, such information that the determination result of the image sensor inspection is “NG” is generated and then, as feedback auxiliary information, “a feedback level of “High” from among three stages of feedback level of “high,” “middle,” and “low” is generated.

Further, as another one of the destination notifications, a server apparatus of the police as the notification destination apparatus 15 is decided, and as feedback information for the server apparatus of the police, such information that the determination result of “NG” of the image sensor inspection has been generated in the inspection of the vehicle state of the vehicle 11 is generated and, as feedback auxiliary information, the feedback level of “high” is generated.

In step S69, the management apparatus 14 transmits the generated feedback information and feedback auxiliary information to a predetermined unit of the vehicle 11 decided as the notification destination. In particular, the cloud server that is the management apparatus 14 transmits the such information that the determination result of the image sensor inspection is “NG” as the feedback information and the feedback auxiliary information indicative of the “high” feedback level, to the control unit 21 of the vehicle 11.

In step S70, the management apparatus 14 transmits the generated feedback information and feedback auxiliary information to the notification destination apparatus 15 decided as the notification destination. In particular, such information that the determination result of the image sensor inspection is “NG” as the feedback information and the feedback auxiliary information indicative of the “high” feedback level are transmitted to the server apparatus of the police as the notification destination apparatus 15 and stored into the server apparatus of the police.

In step S71, the vehicle 11 receives the feedback information and the feedback auxiliary information transmitted thereto from the management apparatus 14 and performs feedback. In particular, since the determination result of the image sensor inspection is “NG” and the feedback level is “high,” the control unit 21 of the vehicle 11 controls the driving unit of the vehicle 11 such that the vehicle 11 does not advance into the autonomous driving lane but advances into the non-autonomous driving lane. Further, a notification that the determination result of the image sensor inspection is “NG” is given by sound to the driver from the notification unit 23.

It is to be noted that, for example, even if the determination result of the sensor device is “NG,” in the case where the feedback level is “low,” only a notification of the result of the determination of “NG” is given to the driver of the vehicle 11, and the running control for a driving lane is not performed.

Then, it is assumed that, if the driver of the vehicle 11 has the image sensor repaired at a later date and causes the vehicle 11 to execute re-inspection for the image sensor inspection, a determination result of “OK” is obtained. In step 72, the vehicle 11 transmits a performance result obtained when the re-inspection for the image sensor inspection is performed, to the management apparatus 14.

In step S73, the management apparatus 14 receives the performance result transmitted thereto from the vehicle 11 and updates the feedback information stored in the storage unit 52. In this example, the management apparatus 14 additionally stores into a part in the storage unit 52 corresponding to the feedback information of the vehicle 11 that the performance result of the re-inspection for the image sensor inspection is “OK.”

In this manner, according to the second particular example of the inspection process, pass/fail is determined using an inspection result (first inspection data) of image sensor inspection by the vehicle 11 itself that is an inspection target vehicle and an inspection result (second inspection data) of image sensor inspection by a different vehicle as the inspection apparatus 12 that is a third party. Then, feedback information is decided and generated on the basis of a result of the determination and is transmitted to the vehicle 11 and the notification destination apparatus 15. In the vehicle 11, feedback is performed and the feedback information of the management apparatus 14 is also updated, on the basis of the feedback information.

### <5. Third Particular Example of Inspection Process>

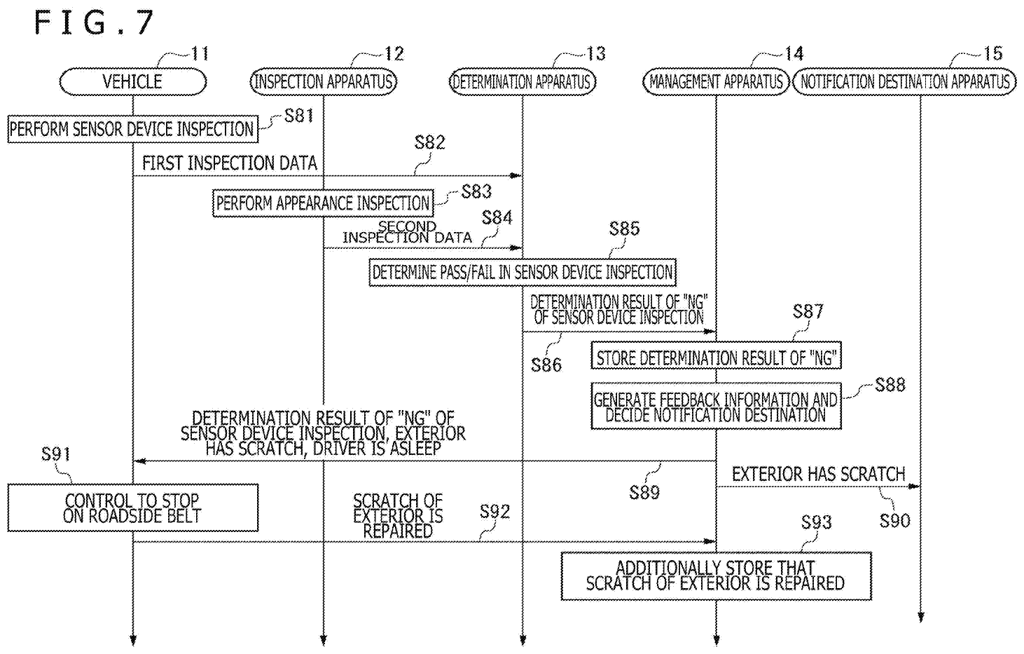

Now, an example of an inspection process for inspecting whether or not a sensor device can function normally from an appearance of a vehicle 11 imaged by an image sensor is described with reference to a flow chart of FIG. 7.

The example of FIG. 7 described below is directed to a case in which the inspection apparatus 12 and the determination apparatus 13 are configured from an RSU and the management apparatus 14 is configured from a cloud server (server apparatus).

Further, it is assumed that, similarly as in the example of FIG. 5, the example of FIG. 7 is an example of an inspection process when the vehicle 11 that is an inspection target vehicle passes a predetermined inspection section set as a motor vehicle inspection and registration place at an entrance of an express way. It is assumed that the express way after the inspection section is passed includes an autonomous driving lane and a non-autonomous driving lane.

First, in step S81, the vehicle 11 performs sensor device inspection (operation check) of each sensor device of the vehicle 11 itself. In step S82, the vehicle 11 transmits a result of the inspection as first inspection data to the RSU as the determination apparatus 13 together with the vehicle identification information. The vehicle identification information includes vehicle information indicative of whether or not the vehicle 11 is a vehicle having a fully automatic operation function. In the present case, it is assumed that the vehicle 11 is a vehicle that does not have a fully automatic operation function.

In step S83, the RSU that is the inspection apparatus 12 images an appearance of the vehicle 11 and performs appearance inspection. The appearance inspection includes inspection not only of the exterior condition of the vehicle 11 such as a dent or a scratch but also a driving situation of the driver and so forth.

In step S84, the RSU that is the inspection apparatus 12 transmits the image obtained by capturing the appearance of the vehicle 11 as second inspection data to the RSU as the determination apparatus 13 together with the vehicle identification information. In the present example, since the inspection apparatus 12 and the determination apparatus 13 are configured from the same RSU, the appearance image of the vehicle 11 as the second inspection data is stored into the RSU.

In step S85, the RSU that is the determination apparatus 13 determines pass/fail of the sensor device inspection using the first inspection data transmitted thereto from the vehicle 11 and the second inspection data by the inspection apparatus 12.

In particular, the determination apparatus 13 determines, from the inspection result of the sensor device transmitted thereto as the first inspection data and the appearance image of the vehicle 11 transmitted thereto as the second inspection data, whether or not the sensor device can function normally.

For example, even if the inspection result of the sensor device by the vehicle 11 itself is normal, if the part at which the sensor device of the vehicle 11 is mounted is dented or the like, then it sometimes occurs that a direction different from a direction to be detected originally is detected. Therefore, the determination apparatus 13 determines from the appearance state of the vehicle 11 whether or not the sensor device can function normally.

Further, the determination apparatus 13 also determines a driving state of the driver included in the appearance image of the vehicle 11, for example, whether or not the driver is in an asleep state.

In step S86, the determination 13 transmits a determination result by determination of pass/fail of the sensor device inspection to the cloud server as the management apparatus 14 together with the vehicle identification information for identifying the vehicle 11. In this example, it was found that the exterior of the vehicle 11 has a scratch as that caused by an accident. Further, it was determined as a driving situation that the driver is in an asleep state. Since, based on the vehicle information included in the vehicle identification information, the vehicle 11 is a vehicle that does not have a fully automatic operation function, the asleep state of the driver is dangerous, and therefore, the determination apparatus 13 sets the determination result to “NG” and transmits this to the management apparatus 14. It is to be noted that, in the case where the vehicle 11 is a vehicle that has a fully automatic operation function, even if the driver is in an asleep state, driving is possible by automatic control, and therefore, the determination result can be set to “OK.”

In step S87, the cloud server that is the management apparatus 14 receives the determination result of “NG” of the sensor device inspection transmitted thereto from the RSU as the determination apparatus 13 and stores it into the storage unit 52. Then, in step S88, the management apparatus 14 decides and generates feedback information and decides notification destinations of the feedback information on the basis of the determination result of “NG” of the sensor device inspection.

In this example, the vehicle 11 is decided as one of the notification destinations and generates, as the feedback information for the vehicle 11, such information that the decision result of the sensor device inspection is “NG,” that the exterior has such a scratch as that caused by an accident, and that the driver is in an asleep state.

Further, a server apparatus of the police and a server apparatus of an insurance company as the notification destination apparatus 15 are decided as other ones of the notification destinations, and such information that the exterior has such a scratch as that caused by an accident is generated as feedback information for the server apparatuses of the police and of the insurance company.

In step S89, the management apparatus 14 transmits the generated feedback information to a predetermined unit of the vehicle 11 decided as the notification destination. In particular, the cloud server that is the management apparatus 14 transmits, as the feedback information, such information that the determination result of the sensor device inspection is “NG,” that the exterior has such a scratch as that caused by an accident, and that the driver is in an asleep state, to the control unit 21 of the vehicle 11.

In step S90, the management apparatus 14 transmits the generated feedback information to the notification destination apparatus 15 decided as the notification destination. In particular, as the feedback information, such information that the exterior has such a scratch as that caused by an accident is transmitted to and stored into the server apparatuses of the police and the insurance company as the notification destination apparatus 15.

In step S91, the vehicle 11 receives the feedback information transmitted from the management apparatus 14 and performs feedback. In particular, since the determination result of the sensor device inspection is “NG” and the driver is in an asleep state, the control unit 21 of the vehicle 11 controls the vehicle 11 to stop on a roadside belt. Further, the vehicle 11 causes the notification unit 23 to output sound for waking up the driver.

It is to be noted that, for example, in the case where the vehicle 11 has a fully automatic operation function, even if the driver is in an asleep state, driving is possible by automatic control. Therefore, the determination result becomes “OK,” and the vehicle 11 is controlled so as to run on the autonomous driving lane.

Then, if the driver of the vehicle 11 has the vehicle 11 repaired at a later date and inputs information of this from an operation unit or the like, then, in step S92, the vehicle 11 transmits, as a performance result, to the management apparatus 14 that the scratch of the exterior has been repaired.

In step S93, the management apparatus 14 receives the performance result transmitted from the vehicle 11 and updates the feedback information stored in the storage unit 52. In this example, the management apparatus 14 additionally stores into a part in the storage unit 52 corresponding to the feedback information of the vehicle 11 that the scratch of the exterior has been repaired.

In this manner, according to the third particular example of the inspection process, pass/fail is determined using an inspection result (first inspection data) of the sensor device inspection by the vehicle 11 itself that is an inspection target vehicle and an inspection result (second inspection data) of an appearance inspection by the RSU as the inspection apparatus 12 that is a third party and the determination apparatus 13, and feedback information is decided and generated on the basis of the determination result and transmitted to the vehicle 11 and the notification destination apparatus 15. In the vehicle 11, feedback is performed and feedback information of the management apparatus 14 is also updated on the basis of the feedback information.

According to the inspection process of the vehicle inspection system 1 to which the present technology is applied, the motor vehicle inspection and registration place can be set not only to a conventional vehicle inspection center but also to a gas station, a predetermined section of a general road, or the like, and vehicle inspection can be performed at shorter intervals. Consequently, since it becomes possible to perform vehicle inspection any time anywhere, the situation of the vehicle can be grasped more dynamically on a real time basis. In the future, even in a vehicle in which a large number of advanced sensor devices or communication apparatuses are incorporated such as a self-driving vehicle, safe autonomous driving can be provided without overlooking even an unexpected failure.

In the example described above, it is described that inspection items and so forth to be performed at a motor vehicle inspection and registration place are not particularly specified and the same inspection is performed at any motor vehicle inspection and registration place. However, for example, the inspection items to be performed may be different between a place at which inspection is performed with the vehicle 11 stopped such as a vehicle inspection center or a gas station and a place at which inspection is performed while the vehicle 11 runs such as a predetermined inspection section set in advance on a road.

As an alternative, inspection items to be performed may be made different from each other depending upon the interval after the preceding inspection, as upon initial inspection and upon continued inspection. In inspection for the first time and inspection performed after a predetermined period of time has passed from the preceding inspection, all inspection items may be performed as initial inspection, but in continued inspection performed within a predetermined period from the preceding inspection, inspection of simplified inspection items that are small in number than those in the initial inspection may be performed.

According to the inspection process of the vehicle inspection system 1 to which the present technology is applied, a vehicle can be inspected more efficiently without intervention of a person, and a fully automatic vehicle inspection system can be implemented. By dynamically performing a check of security standards in a shorter period of time for all parts of the vehicle 11, a safer autonomous driving society can be implemented.

### <6. Example of Configuration of Vehicle>

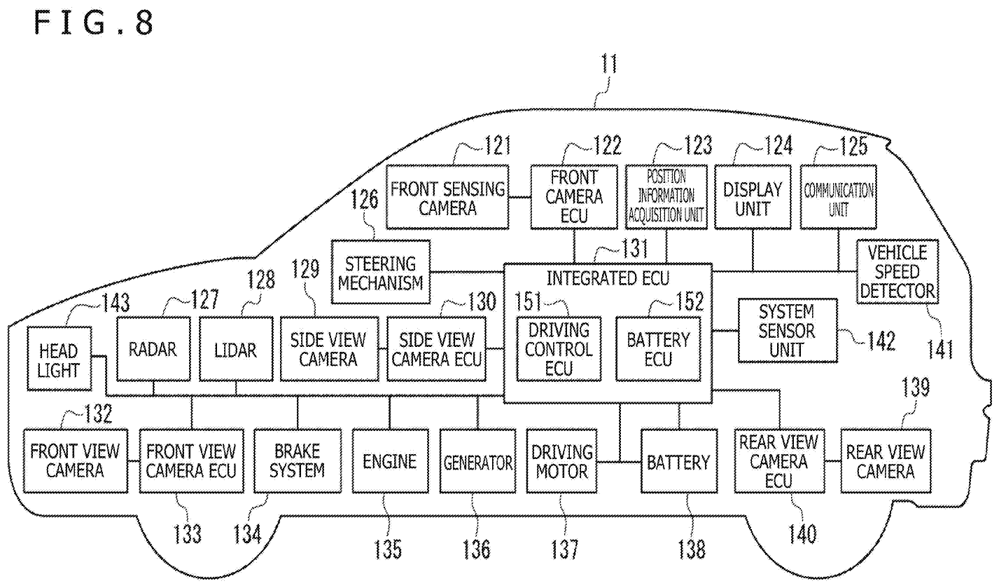

FIG. 8 is a view depicting an example of a configuration of the vehicle 11.

The vehicle 11 includes a front sensing camera 121, a front camera ECU (Electronic Control Unit) 122, a position information acquisition unit 123, a display unit 124, a communication unit 125, a steering mechanism 126, a radar 127, a LIDAR 128, a side view camera 129, a side view camera ECU 130, an integrated ECU 131, a front view camera 132, a front view camera ECU 133, a brake system 134, an engine 135, a generator 136, a driving motor 137, a battery 138, a rear view camera 139, a rear view camera ECU 140, a vehicle speed detection unit 141, a system sensor unit 142, and a headlamp 143.

Although the units provided in the vehicle 11 are connected to each other by a bus for CAN (Controller Area Network) communication, other connection lines and so forth, in order to make the drawing easier to read, the bus, connection lines, and so forth are drawn without particularly distinguishing them.

The front sensing camera 121 includes, for example, a camera for exclusive use for sensing arranged in the proximity of a room mirror in the cabin, and images ahead of the vehicle as an imaging target and outputs a sensing image obtained as a result of the imaging to the front camera ECU 122.

The front camera ECU 122 suitably performs a process for improving the picture quality and so forth for the sensing image supplied from the front sensing camera 121, and then performs image recognition for the sensing image to detect an optional object such as a white line, a pedestrian, or the like from the sensing image. The front camera ECU 122 outputs a result of the image recognition to the bus for CAN communication.

The position information acquisition unit 123 includes, for example, a position information measurement system such as, for example, the GPS (Global Positioning System), and detects the position of the vehicle 11 and outputs position information indicative of a result of the detection to the bus for CAN communication.

The display unit 124 includes, for example, a liquid crystal display panel and is arranged at a predetermined position in the cabin such as a central portion of an instrument panel or the inside of the room mirror. Further, the display unit 124 may be a transmission type display provided in an overlapping relationship with a windshield (windshield) portion or may be a display of a car navigation system. The display unit 124 displays various images under the control of the integrated ECU 131.

The communication unit 125 performs transfer of information with a peripheral vehicle, a portable terminal apparatus possessed by a pedestrian, a roadside device, or an external server apparatus by various kinds of wireless communication such as inter-vehicle communication, vehicle-pedestrian communication, and road-vehicle communication. For example, the communication unit 125 performs road-vehicle communication to transmit vehicle identification information for identifying the vehicle 11 and so forth to a different apparatus such as an RSU.

The steering mechanism 126 performs control of the running direction of the vehicle 11, that is, steering angle control, in response to a steering wheel operation by the driver or a control signal supplied from the integrated ECU 131. The radar 127 is a distance measurement sensor for measuring the distance to a target object such as a vehicle or a pedestrian existing in various directions such as a forward direction or a rearward direction using electromagnetic waves such as a millimeter wave, and outputs a result of the measurement of the distance to the target object to the integrated ECU 131 and so forth. The LIDAR 128 is a distance measurement sensor for measuring the distance to a target object such as a vehicle or a pedestrian existing in various directions such as the forward direction or the rearward direction using a light wave, and outputs a result of the measurement to the distance to the target object to the integrated ECU 131 and so forth.

The side view camera 129 is a camera arranged, for example, in a housing of a side mirror or in the proximity of a side mirror, and captures an image sidewardly of the vehicle 11 (hereinafter also referred to as a side image) including an area that is a blind spot to the driver and supplies the image to the side view camera ECU 130.

The side view camera ECU 130 performs, for the side image supplied from the side view camera 129, an image process for improving the picture quality such as white balance adjustment, and supplies a resulting side image to the integrated ECU 131 through a cable different from the bus for CAN communication.

The integrated ECU 131 includes a plurality of ECUs arranged in the middle of the vehicle 11 such as a driving control ECU 151 and a battery ECU 152, and controls operation of the entire vehicle 11.

For example, the driving control ECU 151 is an ECU for implementing an ADAS (Advanced Driving Assistant System) function or an autonomous driving (Self driving) function, and controls driving (running) of the vehicle 11 on the basis of various kinds of information such as an image recognition result from the front camera ECU 122, position information from the position information acquisition unit 123, and peripheral vehicle information supplied from the communication unit 125, measurement results from the radar 127 and the LIDAR 128, a detection result of the vehicle speed from the vehicle speed detection unit 141, and so forth. In particular, the driving control ECU 151 controls the steering mechanism 126, the brake system 134, the engine 135, the driving motor 137, and so forth to control driving of the vehicle 11. Further, the driving control ECU 151 controls the headlamp 143 on the basis of presence/absence of a headlamp of an oncoming vehicle and so forth supplied as an image recognition result from the front camera ECU 122 to control beam irradiation by the headlamp 143 such as switching between a high beam and a low beam.

It is to be noted that, in the integrated ECU 131, an ECU for exclusive use may be provided for each function such as the ADAS function, the autonomous driving function, or beam control.

Further, the battery ECU 152 controls supply of electric power by the battery 138 and so forth.

The front view camera 132 includes, for example, a camera arranged in the proximity of the front grill, and captures an image forwardly of the vehicle 11 (hereinafter also referred to as as front image) including a region that becomes a blind spot to the driver and supplies the image to the front view camera ECU 133.

The front view camera ECU 133 performs, for the front image supplied from the front view camera 132, an image process for improving the picture quality such as white balance adjustment, and supplies a resulting front image to the integrated ECU 131 through a cable different from the bus for CAN communication.

The brake system 134 operates in response to a braking operation by the driver or to a control signal supplied from the integrated ECU 131 to stop or decelerate the vehicle 11. The engine 135 is a power source of the vehicle 11 and drives the vehicle 11 in response to a control signal supplied from the integrated ECU 131.

The generator 136 generates electric power in response to driving of the engine 135 under the control of the integrated ECU 131. The driving motor 137 is a power source for the vehicle 11, and receives supply of electric power from the generator 136 or the battery 138 and drives the vehicle 11 in response to a control signal supplied from the integrated ECU 131. It is to be noted that whether, upon running of the vehicle 11, the engine 135 is to be driven or the driving motor 137 is to be driven is switched suitably by the integrated ECU 131.

The battery 138 includes, for example, a battery of 12 V, a battery of 200 V, and so forth, and supplies electric power to the components of the vehicle 11 under the control of the battery ECU 152.

The rear view camera 139 includes, for example, a camera arranged in the proximity of the license plate of the tail gate, and captures an image rearwardly of the vehicle 11 (hereinafter also referred to as rear image) including a region that becomes a blind spot to the driver, and supplies the image to the rear view camera ECU 140. For example, the rear view camera 139 is activated when a shift lever not depicted is moved to the reverse (R) position.

The rear view camera ECU 140 performs, for the rear image supplied from the rear view camera 139, an image process for improving the picture quality such as white balance adjustment, and supplies a resulting rear image to the integrated ECU 131 through a cable different from the bus for CAN communication.

The vehicle speed detection unit 141 is a sensor for detecting the vehicle speed of the vehicle 11 and supplies a result of the detection of the vehicle speed to the integrated ECU 131. It is to be noted that the vehicle speed detection unit 141 may calculate an acceleration or a differentiation of the acceleration from the result of the detection of the vehicle speed. For example, the calculated acceleration is used for estimation of a period of time until collision of the vehicle 11 with an object or the like occurs.

The system sensor unit 142 includes various sensors including the engine controlling system sensor, a chassis controlling system sensor, a safe-comfort controlling system sensor, and a communication system sensor described hereinabove with reference to FIG. 1, and detects a predetermined state and so forth and supplies the result of the detection to the integrated ECU 131.

The headlamp 143 operates in response to a control signal supplied from the integrated ECU 131 and outputs a beam to illuminate the front of the vehicle 11.

In the vehicle 11 configured in such a manner as described above, the control unit 21 of FIG. 1 described hereinabove corresponds, for example, to the integrated ECU 131; the communication unit 22 of FIG. 1 corresponds, for example, to the communication unit 125; the notification unit 23 of FIG. 1 corresponds, for example, to the display unit 124; and the inspection unit 24 of FIG. 1 corresponds, for example, to the front sensing camera 121, the side view camera 129, the front view camera 132, the rear view camera 139, the vehicle speed detection unit 141, the system sensor unit 142, and so forth.

### <7. Example of Configuration of Server Apparatus>

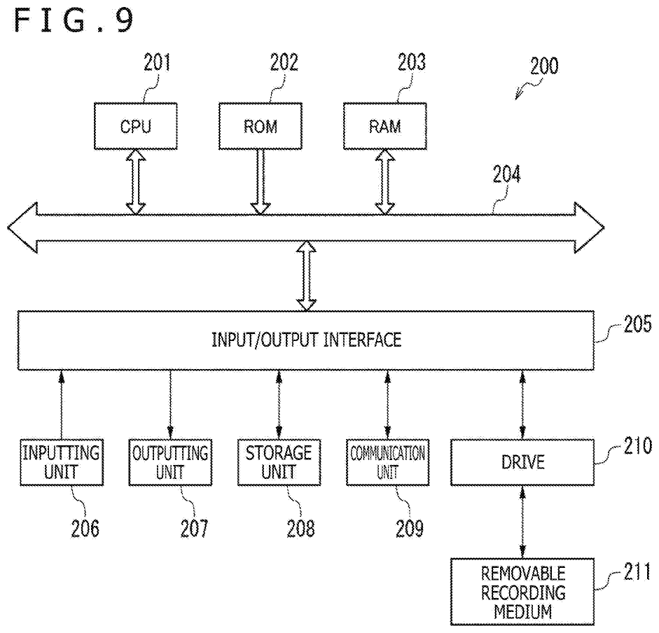

FIG. 9 is a block diagram of an example of a hardware configuration of a server apparatus 200 configured as the determination apparatus 13, the management apparatus 14, or the notification destination apparatus 15.

In the server apparatus 200, a CPU (Central Processing Unit) 201, a ROM (Read Only Memory) 202, and a RAM (Random Access Memory) 203 are connected to each other by a bus 204.

To the bus 204, an input/output interface 205 is further connected. To the input/output interface 205, an inputting unit 206, an outputting unit 207, a storage unit 208, a communication unit 209, and a drive 210 are connected.

The inputting unit 206 includes an inputting switch, a button, a keyboard, a mouse, a microphone, a touch panel, an inputting terminal, an imaging element, or the like. The outputting unit 207 includes a display, a speaker, an output terminal, or the like. The storage unit 208 includes a hard disk, a RAM disk, a nonvolatile memory, or the like. The communication unit 209 includes a network interface or the like for performing communication through various networks such as an in-vehicle communication network such as CAN, LIN, MOST, FlexRay (registered trademark), or Ethernet (registered trademark), a telephone network, a satellite communication network, and the Internet. The drive 210 drives a removable recording medium 211 such as a magnetic disk, an optical disk, a magneto-optical disk, or a semiconductor memory.

In the server apparatus 200 configured in such a manner as described above, the CPU 201 loads a program stored, for example, in the storage unit 208 into the RAM 203 through the input/output interface 205 and the bus 204 and executes the program to perform the series of processes described above. Into the RAM 203, data and so forth necessary when the CPU 201 executes various processes are also suitably stored.

In the server apparatus 200, the program can be installed into the storage unit 208 through the input/output interface 205 by mounding the removable recording medium 211 on the drive 210. Further, the program can be received by the communication unit 209 through a wired or wireless transmission medium such as a local area network, the Internet, or digital satellite broadcasting and installed into the storage unit 208. Alternatively, the program can be installed in advance in the ROM 202 or the storage unit 208.

Also for the hardware configuration of the inspection apparatus 12, a configuration similar to that of FIG. 9 can be adopted.

It is to be noted that, in the present specification, the steps described in the flow charts may not only be executed in a time series in accordance with the sequence described but may also be executed, even if they are not processed in a time series, in parallel or at a necessary timing such as when the program is called.

It is to be noted that, in the present specification, the term “system” is used to represent an aggregation of plural components (devices, modules (parts) and so forth) and it does not matter whether or not all components are accommodated in the same housing. Accordingly, both plural apparatuses accommodated in separate housings and connected to each other through a network and one apparatus where plural modules are accommodated in a single housing are a system.

The embodiment of the present technology is not limited to the embodiments described hereinabove, and various alterations can be made without departing from the subject matter of the present disclosure.

For example, a form that is a combination of all or part of the plural embodiments described above can be adopted.

For example, the present technology can assume a configuration for cloud computing in which one function is shared and processed cooperatively by plural devices through a network.

Further, the steps described hereinabove in connection with the flow charts can be executed by a single device or can be executed by sharing by plural devices.

Furthermore, where one step includes plural processes, the plural processes included in the one step can be executed by a single device and can also be executed by sharing by plural devices.

It is to be noted that the advantageous effects described in the present specification are exemplary to the last and are not restrictive, and advantageous effects other than those described in the present specification may be applicable.

It is to be noted that the present technology can also take such configurations as described below.

(1)

A management apparatus, including:

a decision unit configured to use first inspection data that is a result of inspection of an inspection target vehicle by the vehicle itself and second inspection data that is a result of inspection of the inspection target vehicle by a third party to decide feedback information based on a result of determination obtained when a vehicle state of the inspection target vehicle is determined; and

a communication unit configured to transmit the feedback information to the inspection target vehicle.

(2)

The management apparatus according to (1) above, in which

the feedback information includes improvement instruction information for the inspection target vehicle.

(3)

The management apparatus according to (1) or (2) above, in which

the feedback information includes control information for remotely controlling the inspection target vehicle.

(4)

The management apparatus according to any one of (1) to (3) above, in which

the communication unit transmits the feedback information to a different apparatus as well.

(5)

The management apparatus according to any one of (1) to (4) above, further including:

a storage unit configured to store the feedback information, wherein

where the communication unit receives a performance result obtained when a predetermined process is performed on the basis of the feedback information, from the inspection target vehicle, the feedback information stored in the storage unit is updated.

(6)

The management apparatus according to any one of (1) to (5) above, further including:

a determination unit configured to determine a vehicle state of the inspection target vehicle using the first inspection data and the second inspection data to generate the result of determination.

(7)

A vehicle, including:

an inspection unit configured to inspect the vehicle itself that is an inspection target vehicle; and

a communication unit configured to transmit first inspection data based on a result of the inspection by the inspection unit and receive feedback information based on a result of determination obtained when the vehicle state of the inspection target vehicle is determined using the first inspection data and second inspection data based on a result of inspection obtained when a third party other than the inspection target vehicle inspects the inspection target vehicle.

(8)

The vehicle according to (7) above, in which

the communication unit transmits a result of performance obtained when a predetermined process or work is performed in response to the feedback information, to an apparatus from which the feedback information is transmitted.

(9)

The vehicle according to (7) or (8) above, in which

the communication unit transmits the first inspection data together with vehicle identification information for identifying the vehicle.

(10)

The vehicle according to any one of (7) to (9) above, in which

the communication unit transmits the first inspection data together with at least one of vehicle inspection situation information relating to a situation when inspection is performed, inspection history information relating to inspection in the past, and feedback history information relating to the feedback information in the past.

(11)

The vehicle according to any one of (7) to (10) above, in which

the inspection unit starts inspection of the vehicle itself where the vehicle arrives at a predetermined inspection section on a road.

(12)

An inspection apparatus, including:

an inspection unit configured to inspect a vehicle that is an inspection target vehicle; and

a communication unit configured to transmit, to a determination apparatus that determines a vehicle state of the inspection target vehicle using first inspection data based on a result of inspection by the inspection target vehicle itself and second inspection data based on a result of the inspection by the inspection unit, the second inspection data.

(13)

The inspection apparatus according to (12) above, in which

the communication unit transmits the second inspection data to the determination apparatus together with vehicle identification information for identifying the vehicle.

(14)

The inspection apparatus according to (12) or (13) above, in which

the communication unit transmits the second inspection data to the determination apparatus together with at least one of vehicle inspection situation information relating to a situation when inspection is performed, inspection history information relating to inspection in the past, and feedback history information relating to the feedback information in the past.

(15)

The inspection apparatus according to (14) above, in which

the vehicle inspection situation information includes inspection apparatus identification information for identifying the inspection apparatus.

(16)

The inspection apparatus according to any one of (12) to (15) above, in which

the inspection apparatus includes a vehicle.

(17)

The inspection apparatus according to any one of (12) to (15) above, in which

the inspection apparatus includes an RSU.

(18)

The inspection apparatus according to any one of (12) to (17), in which

the inspection unit starts inspection of the vehicle when the vehicle passes a predetermined inspection section on a road.

(19)

A vehicle inspection system, including:

a vehicle that is an inspection target vehicle;

an inspection apparatus configured to inspect, as a third party, the vehicle; and

a management apparatus configured to transmit feedback information based on a result of determination obtained when a vehicle state of the vehicle is determined using first inspection data from the vehicle and second inspection data from the inspection apparatus, to the vehicle, wherein

the vehicle includes
a first inspection unit configured to inspect the vehicle itself, and
a first communication unit configured to transmit the first inspection data on the basis of a result of the inspection by the first inspection unit and receive the feedback information,

the inspection apparatus includes
a second inspection unit configured to inspect the vehicle, and
a second communication unit configured to transmit the second inspection data on the basis of a result of the inspection by the second inspection unit, and

the management apparatus includes
a decision unit configured to decide the feedback information on the basis of the result of the determination, and
a third communication unit configured to transmit the feedback information to the vehicle.
   (20)

An information processing method for a vehicle inspection system that includes a vehicle that is an inspection target vehicle, an inspection apparatus configured to inspect, as a third party, the vehicle, and a management apparatus configured to transmit feedback information based on a result of determination obtained when a vehicle state of the vehicle is determined, to the vehicle, the information processing method including:

inspecting, by the vehicle, the vehicle itself and transmitting first inspection data on the basis of a result of the inspection;

inspecting, by the inspection apparatus, the vehicle and transmitting second inspection data on the basis of a result of the inspection;

transmitting, by the management apparatus, the feedback information based on a result of determination obtained when the management apparatus determines a vehicle state of the vehicle using the first inspection data and the second inspection data, to the vehicle; and

receiving, by the vehicle, the feedback information.

### REFERENCE SIGNS LIST

1 Vehicle inspection system, 11 Vehicle, 12 inspection apparatus, 13 Determination apparatus, 14 Management apparatus, 15 Notification destination apparatus, 21 Control unit, 22 Communication unit, 23 Notification unit, 24 Inspection unit, 31 Vehicle recognition unit, 32 Inspection unit, 33 Communication unit, 41 Determination unit, 42 Communication unit, 51 Communication unit, 52 Storage unit, 53 Communication unit, 61 Communication unit, 62 Storage unit, 200 Server apparatus, 201 CPU, 202 ROM, 203 RAM, 206 Inputting unit, 207 Outputting unit, 208 Storage unit, 209 Communication unit, 210 Drive

1. A management apparatus, comprising:
a decision unit configured to use first inspection data that includes a result of inspection of an inspection target vehicle by the vehicle itself and second inspection data that includes a result of inspection of the inspection target vehicle by a third party to decide feedback information based on a result of determination obtained when a vehicle state of the inspection target vehicle is determined; and
a communication unit configured to transmit the feedback information to the inspection target vehicle.

2. The management apparatus according to claim 1, wherein
the feedback information includes improvement instruction information for the inspection target vehicle.

3. The management apparatus according to claim 1, wherein
the feedback information includes control information for remotely controlling the inspection target vehicle.

4. The management apparatus according to claim 1, wherein
the communication unit transmits the feedback information to another apparatus as well.

5. The management apparatus according to claim 1, further comprising:
a storage unit configured to store the feedback information, wherein
in a case where the communication unit receives a performance result obtained when a predetermined process is performed on a basis of the feedback information, from the inspection target vehicle, the feedback information stored in the storage unit is updated.

6. The management apparatus according to claim 1, further comprising:
a determination unit configured to determine a vehicle state of the inspection target vehicle using the first inspection data and the second inspection data to generate the result of determination.

7. A vehicle, comprising:
an inspection unit configured to inspect the vehicle itself that is an inspection target vehicle; and
a communication unit configured to transmit first inspection data based on a result of the inspection by the inspection unit and receive feedback information based on a result of determination obtained when the vehicle state of the inspection target vehicle is determined using the first inspection data and second inspection data based on a result of inspection obtained when a third party other than the inspection target vehicle inspects the inspection target vehicle.

8. The vehicle according to claim 7, wherein
the communication unit transmits a result of performance obtained when a predetermined process or work is performed in response to the feedback information to an apparatus from which the feedback information is transmitted.

9. The vehicle according to claim 7, wherein
the communication unit transmits the first inspection data together with vehicle identification information for identifying the vehicle.

10. The vehicle according to claim 7, wherein
the communication unit transmits the first inspection data together with at least one of vehicle inspection situation information relating to a situation when inspection is performed, inspection history information relating to inspection in the past, or feedback history information relating to the feedback information in the past.

11. The vehicle according to claim 7, wherein
the inspection unit starts inspection of the vehicle itself in a case where the vehicle arrives at a predetermined inspection section on a road.

12. An inspection apparatus, comprising:
an inspection unit configured to inspect a vehicle that is an inspection target vehicle; and
a communication unit configured to transmit, to a determination apparatus that determines a vehicle state of the inspection target vehicle using first inspection data based on a result of inspection by the inspection target vehicle itself and second inspection data based on a result of the inspection by the inspection unit, the second inspection data.

13. The inspection apparatus according to claim 12, wherein
the communication unit transmits the second inspection data to the determination apparatus together with vehicle identification information for identifying the vehicle.

14. The inspection apparatus according to claim 12, wherein
the communication unit transmits the second inspection data to the determination apparatus together with at least one of vehicle inspection situation information relating to a situation when inspection is performed, inspection history information relating to inspection in the past, or feedback history information relating to the feedback information in the past.

15. The inspection apparatus according to claim 12, wherein
the vehicle inspection situation information includes inspection apparatus identification information for identifying the inspection apparatus.

16. The inspection apparatus according to claim 12, wherein
the inspection apparatus includes a vehicle.

17. The inspection apparatus according to claim 12, wherein
the inspection apparatus includes an RSU.

18. The inspection apparatus according to claim 12, wherein
the inspection unit starts inspection of the vehicle in a case where the vehicle passes a predetermined inspection section on a road.

19. A vehicle inspection system, comprising:
a vehicle that is an inspection target vehicle;
an inspection apparatus configured to inspect, as a third party, the vehicle; and
a management apparatus configured to transmit feedback information based on a result of determination obtained when a vehicle state of the vehicle is determined using first inspection data from the vehicle and second inspection data from the inspection apparatus, to the vehicle, wherein
the vehicle includes
a first inspection unit configured to inspect the vehicle itself, and
a first communication unit configured to transmit the first inspection data on the basis of a result of the inspection by the first inspection unit and receive the feedback information,
the inspection apparatus includes
a second inspection unit configured to inspect the vehicle, and
a second communication unit configured to transmit the second inspection data on the basis of a result of the inspection by the second inspection unit; and
the management apparatus includes
a decision unit configured to decide the feedback information on the basis of the result of the determination, and
a third communication unit configured to transmit the feedback information to the vehicle.

20. An information processing method for a vehicle inspection system that includes a vehicle that is an inspection target vehicle, an inspection apparatus configured to inspect, as a third party, the vehicle, and a management apparatus configured to transmit feedback information based on a result of determination obtained when a vehicle state of the vehicle is determined, to the vehicle, the information processing method comprising:
inspecting, by the vehicle, the vehicle itself and transmitting first inspection data on the basis of a result of the inspection;
inspecting, by the inspection apparatus, the vehicle and transmitting second inspection data on the basis of a result of the inspection;
transmitting, by the management apparatus, the feedback information based on a result of determination obtained when the management apparatus determines a vehicle state of the vehicle using the first inspection data and the second inspection data to the vehicle; and
receiving, by the vehicle, the feedback information.
